(19) United States
(12) Patent Application Publication
(10) Pub. No.: US 2017/0205993 A1
(43) Pub. Date: Jul. 20, 2017

(54) TOUCH SCREEN RESPONSE METHOD AND TERMINAL

(71) Applicant: GIONEE COMMUNICATION EQUIPMENT CO.,LTD. SHENZHEN, Shenzhen (CN)

(72) Inventor: Sanxin WANG, Shenzhen (CN)

(73) Assignee: GIONEE COMMUNICATION EQUIPMENT CO.,LTD. SHENZHEN, Shenzhen (CN)

(21) Appl. No.: 15/326,611

(22) PCT Filed: Dec. 11, 2014
(86) PCT No.: PCT/CN2014/093605

§ 371 Date: Jan. 16, 2017

(30) Foreign Application Priority Data
Jul. 18, 2014 (CN) 201410345079.1
Jul. 18, 2014 (CN) 201410346051.X

(51) Int. Cl. G06F 3/0484; G06F 3/0489; G06F 3/01; G06F 3/0488

(52) U.S. Cl. CPC G06F 3/04845; G06F 3/0488; G06F 3/0489; G06F 3/017

(57) ABSTRACT

Embodiments of the present disclosure disclose a page switching method. The method includes: acquiring switching indication information for switching a first page, the switching indication information including a switching indication direction for switching from the first page to a second page; setting a direction opposite to the switching indication direction to be a movement indication direction of a background page of the first page and the second page; and controlling switching from the first page to the second page according to the switching indication information, and controlling movement of the background page according to the movement indication direction. A relative movement speed for page switching can increase, thereby improving user experience.

### CROSS REFERENCE TO RELATED APPLICATIONS

This application claims priority to Chinese Patent Application No. 20140345079.1, entitled INTERFACE SWITCHING METHOD, filed on Jul. 18, 2014, submitted to Patent Office of China, and claims priority to Chinese Patent Application No. 201410346051.X, entitled TERMINAL, filed on Jul. 18, 2014, submitted to Patent Office of China, contents of all of which are hereby incorporated in their entireties by reference.

### TECHNICAL FIELD

The present disclosure relates to electronic technical field, and particularly to a page switching method and a terminal.

### BACKGROUND

With development and improvement of electronic technology, mobile phones and tablet computers have become a necessity in daily life. These terminals can be used for communication, and can also be used for file transmission, videoing, playing games, and so on.

With development of technology, high performances of terminals are required. For example, when switching a page currently displayed, if the system of the terminal is in a busy state, or the configuration of the terminal is low, a lag phenomenon easily occurs during page switching, which may bring bad influence on user experience.

### SUMMARY

Embodiments of the present disclosure provide a page switching method, which can increase a relative movement speed for page switching, and improve user experience.

An embodiment of the present disclosure provides a page switching method which may include: acquiring switching indication information for switching a first page, the switching indication information including a switching indication direction for switching from the first page to a second page; setting a direction opposite to the switching indication direction to be a movement indication direction of a background page of the first page and the second page; and controlling switching from the first page to the second page according to the switching indication information, and controlling movement of the background page according to the movement indication direction.

An embodiment of the present disclosure provides a terminal which may include a switching information acquiring unit configured to acquire switching indication information for switching a first page, and the switching indication information includes a switching indication direction for switching from the first page to a second page. The terminal may further include a direction setting unit configured to set a direction opposite to the switching indication direction to be a movement indication direction of a background page of the first page and the second page, and a control unit configured to control switching from the first page to the second page according to the switching indication information, and control movement of the background page according to the movement indication direction.

In the embodiments of the present disclosure, the switching indication information including the switching indication direction for switching from the first page to the second page is acquired, the movement indication direction of the background page of the first page and the second page is determined according to the switching indication information, the background page is moved according to the movement indication direction, and the movement indication direction is opposite to the switching indication direction, thus a relative movement speed relative to movement of the background page when the terminal switches from the first page to the second page increases, thereby improving user experience.

### BRIEF DESCRIPTION OF THE DRAWINGS

To better illustrate the technical solution of embodiments of the present disclosure, the following descriptions will briefly illustrate the accompanying drawings described in the embodiments. Obviously, the following described accompanying drawings are some embodiments of the present disclosure. Persons skilled in the art can derive other accompanying drawings from these accompanying drawings without creative effort.

FIG. 1 is a flow chart of a page switching method in accordance with an embodiment of the present disclosure.

FIG. 2 is a flow chart of a page switching method in accordance with another embodiment of the present disclosure.

FIG. 3 is a schematic view of a first example of background page movement in accordance with an embodiment of the present disclosure.

FIG. 4 is a schematic view of a second example of background page movement in accordance with an embodiment of the present disclosure.

FIG. 5 is a schematic view of an example of background page longitudinal movement in accordance with an embodiment of the present disclosure.

FIG. 6 is a diagrammatic view of a terminal in accordance with an embodiment of the present disclosure.

FIG. 7 is a diagrammatic view of a terminal in accordance with another embodiment of the present disclosure.

FIG. 8 is a diagrammatic view of a terminal in accordance with yet another embodiment of the present disclosure.

### DETAILED DESCRIPTION

The technical solution of embodiments of the present disclosure will be described clearly and completely in combination with the accompanying drawings of the embodiments of the present disclosure. Obviously, the described embodiments are a part of embodiments of the present disclosure, and not all of the embodiments. According to the embodiments of the present disclosure, other embodiments obtained by those skilled in the art without creative effort all fall within the protection scope of the present disclosure.

A page switching method provided by embodiments of the present disclosure can be applied to a scenario of switching between a home page of a terminal and another page. For example, the terminal acquires switching indication information for switching the home page, and the switching indication information includes a switching indication direction for switching from the home page to the another page. The terminal sets a direction opposite to the switching indication direction to be a movement indication direction of a background page of the home page and the another page. The terminal controls switching from the home page to the another page according to the switching indication information, and controls movement of the background page according to the movement indication direction. The movement indication direction is opposite to the switching indication direction, thus a relative movement speed relative to movement of the background page when switching from a first page to a second page increases, which makes a user feel that it is fluent to switch pages, thereby improving user experience.

The terminal referred in embodiments of the present disclosure can include a computer, a tablet computer, a smart phone, a laptop computer, a handheld computer, a mobile internet device (MID), and so on.

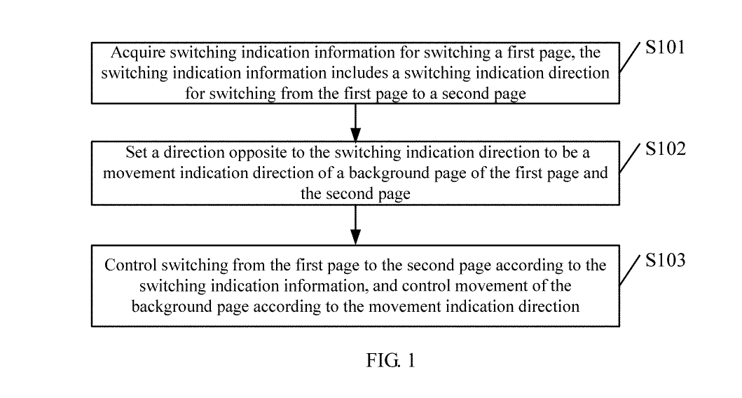

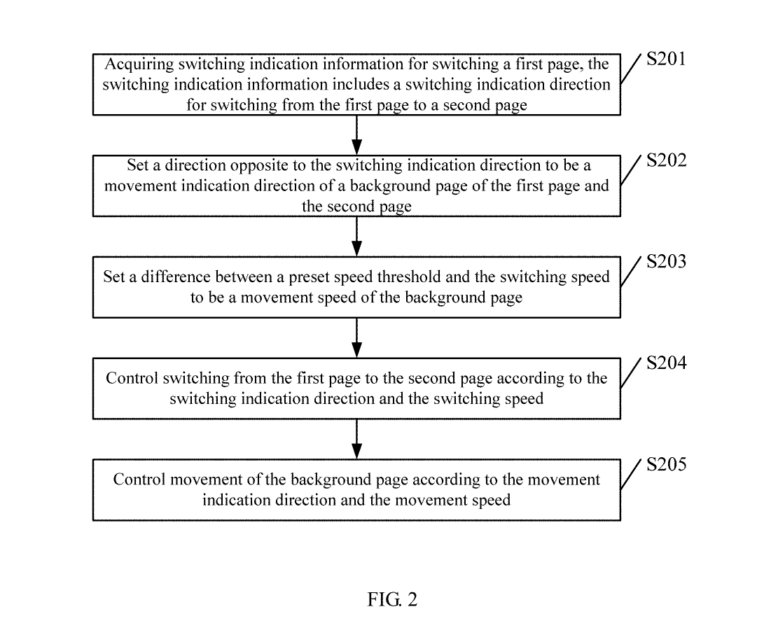

The following will specifically illustrate page switching methods provided by embodiments of the present disclosure in conjunction with FIG. 1 and FIG. 2.

Referring to FIG. 1, a flow chart of a page switching method provided by an embodiment of the present disclosure is illustrated. As is illustrated by FIG. 1, the method of the embodiment of the present disclosure includes steps S101-S103.

S101, switching indication information for switching a first page is acquired, and the switching indication information includes a switching indication direction for switching from the first page to a second page.

Specifically, when it needs to switch from the first page currently displayed by the terminal to the second page, the terminal can acquire the switching indication information for switching the first page. Furthermore, the terminal can acquire the switching indication information for switching the first page from a preset input region of the terminal, and the switching indication information includes the switching indication direction for switching from the first page to the second page. The preset input region includes a physical keyboard, a touch screen, and an input region within a preset distance range of the terminal. If the operation manner of the terminal is the touch operation performed on the touch screen, the switching indication information input by the user can be the switching indication information input by the touch manner. If the operation manner of the terminal is the physical keyboard operation performed on the physical keyboard, the switching indication information input by the user can be the switching indication information input by the physical keyboard manner. If the operation manner of the terminal is the control operation performed in the input region within the preset distance range of the terminal, the switching indication information input by the user can be the switching indication information input by performing gesture and sliding operation in the input region.

S102, a direction opposite to the switching indication direction is set to be a movement indication direction of a background page of the first page and the second page.

Specifically, the terminal can set the movement indication direction of the background page of the first page and the second page according to the switching indication direction of the switching indication information, and the movement indication direction is opposite to the switching indication direction.

S103, the terminal controls switching from the first page to the second page according to the switching indication information, and controls movement of the background page according to the movement indication direction and the movement speed.

Specifically, the terminal can control switching from the first page to the second page according to the switching indication direction, and control movement of the background page according to the movement indication direction.

In the embodiment of the present disclosure, the switching indication information including the switching indication direction for switching from the first page to the second page is acquired, the movement indication direction of the background page of the first page and the second page is determined according to the switching indication information, the background page is moved according to the movement indication direction, and the movement indication direction is opposite to the switching indication direction, thus a relative movement speed relative to movement of the background page when switching from the first page to the second page increases, thereby improving user experience.

Referring to FIG. 2, a flow chart of a page switching method provided by another embodiment of the present disclosure is illustrated. As illustrated by FIG. 2, the method of the embodiment of the present disclosure includes steps S201-S205.

S201, switching indication information for switching a first page is acquired, and the switching indication information includes a switching indication direction for switching from the first page to a second page.

Specifically, when it needs to switch from the first page currently displayed by the terminal to the second page, the terminal can acquire the switching indication information for switching the first page. Furthermore, the terminal can acquire the switching indication information for switching the first page from a preset input region of the terminal, and the switching indication information includes the switching indication direction for switching from the first page to the second page. The preset input region includes a physical keyboard, a touch screen, and a preset input region within a preset distance range of the terminal. If the operation manner of the terminal is the touch operation performed on the touch screen, the switching indication information input by the user can be the switching indication information input by the touch manner. If the operation manner of the terminal is the physical keyboard operation performed on the physical keyboard, the switching indication information input by the user can be the switching indication information input by the physical keyboard manner. If the operation manner of the terminal is the control operation performed in the input region within the preset distance range of the terminal, the switching indication information input by the user can be the switching indication information input by performing gesture and sliding operation in the input region. The switching indication information not only includes the movement indication information for switching from the first page to the second page, and can further include a switching speed for switching from the first page to the second page. The switching speed can be input by the above operation manners, and can also be a preset switching speed. That is, when page switching is triggered, page switching is performed according to the preset switching speed.

S202, a direction opposite to the switching indication direction is set to be a movement indication direction of a background page of the first page and the second page.

S203, a difference between the preset speed threshold and the switching speed is set to be a movement speed of the background page.

Specifically, the terminal can set the movement indication direction and the movement speed of the background page of the first page and the second page according to the switching indication direction and the switching speed. Furthermore, setting the movement indication information of the background page can include setting the direction opposite to the switching indication direction to be the movement indication direction of the background page and setting the difference between the preset speed threshold and the switching speed to be the movement speed of the background page. Based on user experience, it can be determined that when the speed exceeds 120 fps, the user may feel dizzy, and when the speed is less than 60 fps, a lag phenomenon may occur. Therefore, the terminal can set the preset speed threshold, and the preset speed threshold falls within a range from 60 fps to 120 fps. As the movement indication direction of the background page is set to be opposite to the switching indication direction, a sum of the switching speed and the movement speed needs to be equal to the preset speed threshold.

It can be understood that the switching speed and the movement speed are absolute speeds, and the preset speed threshold can be a relative speed relative to movement of the background page when switching from the first page to the second page.

S204, the terminal controls switching from the first page to the second page according to the switching indication direction and the switching speed.

S205, the terminal controls movement of the background page according to the movement indication direction and the movement speed.

Specifically, the terminal can control switching from the first page to the second page according to the switching indication direction and the switching speed, and control movement of the background page according to the movement indication direction and the movement speed.

What needs to be illustrated is that in the embodiment of the present disclosure, an image displayed in the background page can be any frame image of a combination image combined by at least one frame. That is, an image is independently displayed in the background page every a preset time interval. The terminal can control movement from a first image of the combination image combined by at least one frame displayed in the background page to a second image of the combination image combined by at least one frame according to the movement indication direction and the movement speed, the first image can be a frame of the combination image, and the second image can be a frame of the combination image. Or the image displayed in the background page can be a dynamic image, and the terminal can control movement of a moveable object of the dynamic image displayed in the background page according to the movement indication direction and the movement speed. For example, if the dynamical image includes a little person which is running, and the switching indication direction is sliding toward left of the screen of the terminal, the little person can run to the left or run to the right according to the movement indication direction. The specific movement indication direction can be set by the user. Or the image displayed in the background page can be a part of a preset image, and the terminal can control movement from a first part of the preset image displayed in the background page to a second part of the preset image according to the movement indication direction and the movement speed. For example, a part of the preset image is displayed in the background page, and when the background page is moved, the displayed image is coherent.

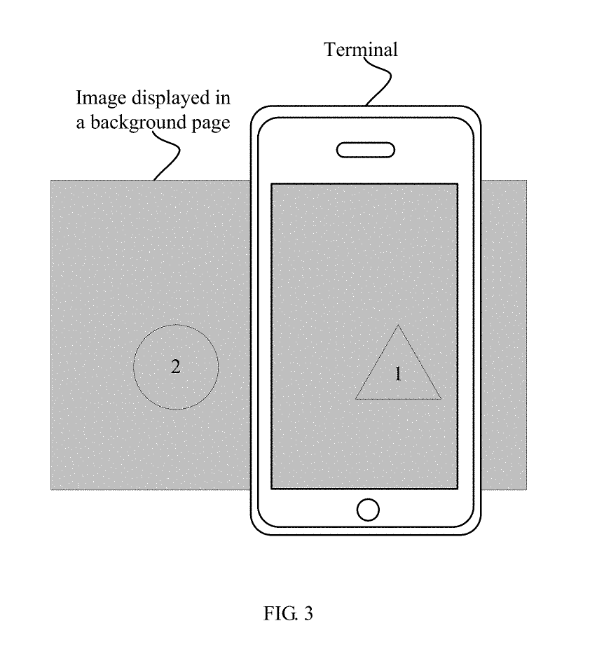

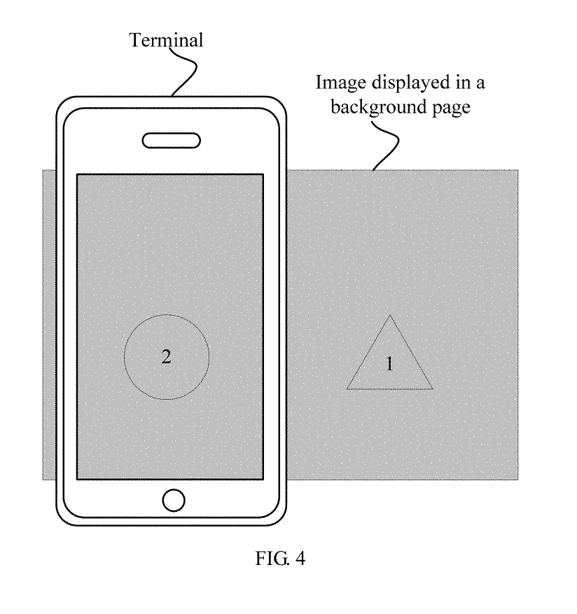

It can be understood that the switching indication direction can be an upward direction, a downward direction, a left direction, or a right direction of a plane, that is, switching is performed in the plane. Referring to FIG. 3 and FIG. 4, FIG. 3 indicates that before switching from the first page to the second page, a part of a preset image is displayed in the background page. The part can include a pattern 1, and the remaining of the preset image is not displayed. When the switching indication direction indicates that when the terminal controls switching from the first page to the second page in a left direction, the image displayed in the background page can be moved to right, and during the movement process, the image is coherent. As is illustrated by FIG. 4, when the terminal controls switching from the first page to the second page, another part of the preset image can be displayed in the background page. The part includes a pattern 2, and the remaining of the preset image is not displayed. What needs to be illustrated is that the pattern 1 and the pattern 2 are just used to illustrate the process of moving the image of the background page, and the pattern 1 and the pattern 2 can be determined by the preset image which is selected as the background by the user.

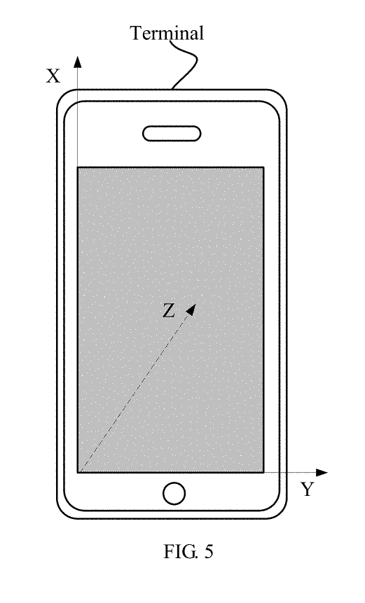

The switching indication direction can further include a longitudinal direction of a three-dimension space, for example, when “window” effects switch is performed. Referring to FIG. 5, relative to the terminal, a spatial rectangular coordinate system can be set for the background page. If the terminal controls switching from the first page to the second page in the “window” effects manner, that is, when the terminal controls switching from the first page to the second page in a direction parallel to the Z-axis, the image displayed in the background page can be moved in the direction parallel to the Z-axis. For example, if the switching indication direction for switching from the first page to the second page is parallel to the positive direction of the Z-axis, the image displayed in the background page can be moved in the negative direction of the Z-axis. Certainly, the manner of adopting the coordinate axis is just an example for illustrating the longitudinal direction of the three-dimension space, and the terminal may not set the spatial rectangular coordinate system.

In the embodiment of the present disclosure, the switching indication information including the switching indication direction and the switching speed for switching from the first page to the second page is acquired, the movement indication direction and the movement speed of the background page of the first page and the second page are determined according to the switching indication information, the background page is moved according to the movement indication direction and the movement speed, and the movement indication direction is opposite to the switching indication direction, thus a relative movement speed relative to movement of the background page when switching from the first page to the second page increases, and by setting the range of the preset speed threshold, it can be ensured that the effect of relative movement cannot disturb the user, which can further improve user experience.

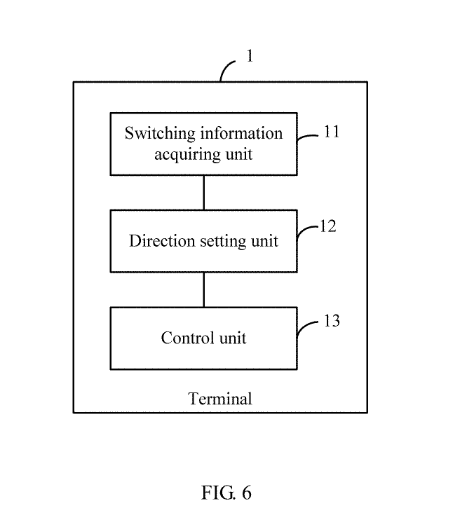

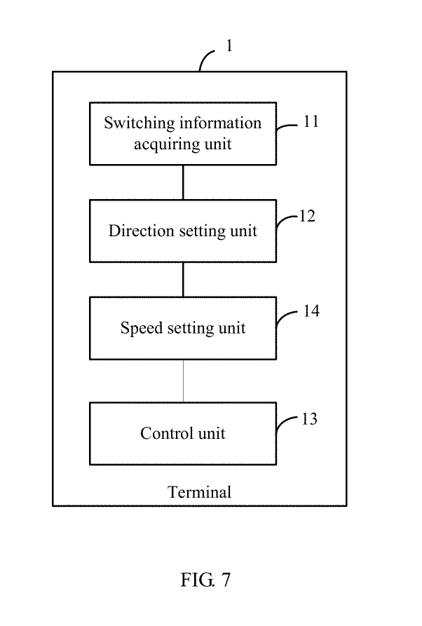

The following will specifically illustrate a terminal of an embodiment of the present disclosure in conjunction with FIG. 6 and FIG. 7. What needs to be illustrated is that the terminals illustrated by FIG. 6 and FIG. 7 respectively execute the methods illustrated by embodiments of FIG. 1 and FIG. 2. For easy illustration, the parts related to the embodiment of the present disclosure are illustrated, and specific details are not disclosed. Embodiments illustrated by FIG. 1 and FIG. 2 are referred.

Referring to FIG. 6, a diagrammatic view of a terminal in accordance with an embodiment of the present disclosure is provided. As illustrated by FIG. 6, a terminal 1 of an embodiment of the present disclosure can include a switching information acquiring unit 11, a direction setting unit 12, and a control unit 13.

The switching information acquiring unit 11 is configured to acquire switching indication information for switching a first page, and the switching indication information includes a switching indication direction for switching from the first page to a second page.

Specifically, when it needs to switch from the first page currently displayed by the terminal 1 to the second page, the switching information acquiring unit 11 can acquire the switching indication information for switching the first page. Furthermore, the switching information acquiring unit 11 can acquire the switching indication information for switching the first page from a preset input region of the terminal 1, and the switching indication information includes the switching indication direction for switching from the first page to the second page. The preset input region includes a physical keyboard, a touch screen, and an input region within a preset distance range of the terminal 1. If the operation manner of the terminal 1 is the touch operation performed on the touch screen, the switching indication information input by the user can be the switching indication information input by the touch manner. If the operation manner of the terminal 1 is the physical keyboard operation performed on the physical keyboard, the switching indication information input by the user can be the switching indication information input by the physical keyboard manner. If the operation manner of the terminal 1 is the control operation performed in the input region within the preset distance range of the terminal 1, the switching indication information input by the user can be the switching indication information input by performing gesture and sliding operation in the input region.

The direction setting unit 12 is configured to set a direction opposite to the switching indication direction to be a movement indication direction of a background page of the first page and the second page.

Specifically, the direction setting unit 12 can set the movement indication direction of the background page of the first page and the second page according to the switching indication direction of the switching indication information, and the movement indication direction is opposite to the switching indication direction.

The control unit 13 is configured to control switching from the first page to the second page according to the switching indication information, and control movement of the background page according to the movement indication direction.

Specifically, the control unit 13 can control switching from the first page to the second page according to the switching indication direction, and control movement of the background page according to the movement indication direction.

In the embodiment of the present disclosure, the switching indication information including the switching indication direction for switching from the first page to the second page is acquired, the movement indication direction of the background page of the first page and the second page is determined according to the switching indication information, the background page is moved according to the movement indication direction, and the movement indication direction is opposite to the switching indication direction, thus a relative movement speed relative to movement of the background page when switching from the first page to the second page increases, thereby improving user experience.

Referring to FIG. 7, a diagrammatic view of a terminal in accordance with an embodiment of the present disclosure is provided. As is illustrated by FIG. 7, the terminal 1 in accordance with an embodiment of the present disclosure can include the switching information acquiring unit 11, the direction setting unit 12, the control unit 13, and a speed setting unit 14.

The switching information acquiring unit 11 is configured to acquire switching indication information for switching a first page, and the switching indication information includes a switching indication direction for switching from the first page to the second page.

Specifically, when it needs to switch from the first page currently displayed by the terminal 1 to the second page, the switching information acquiring unit 11 can acquire the switching indication information for switching the first page. Furthermore, the switching information acquiring unit 11 can acquire the switching indication information for switching the first page from a preset input region of the terminal 1, and the switching indication information includes the switching indication direction for switching from the first page to the second page. The preset input region includes a physical keyboard, a touch screen, and an input region within a preset distance range of the terminal 1. If the operation manner of the terminal 1 is the touch operation performed on the touch screen, the switching indication information input by the user can be the switching indication information input by the touch manner. If the operation manner of the terminal 1 is the physical keyboard operation performed on the physical keyboard, the switching indication information input by the user can be the switching indication information input by the physical keyboard manner. If the operation manner of the terminal 1 is the control operation performed in the input region within the preset distance range of the terminal 1, the switching indication information input by the user can be the switching indication information input by performing gesture and sliding operation in the input region. The switching indication information not only includes the movement indication information for switching from the first page to the second page, and can further include a switching speed for switching from the first page to the second page. The switching speed can be input by the above operation manners, and can also be a preset switching speed. That is, when page switching is triggered, page switching is performed according to the preset switching speed.

The direction setting unit 12 is configured to set the direction opposite to the switching indication direction to be the movement indication direction of a background page of the first page and the second page.

The speed setting unit 14 is configured to set a difference between the preset speed threshold and the switching speed to be a movement speed of the background page.

Specifically, the direction setting unit 12 can set the direction opposite to the switching indication direction to be the movement indication direction of the background page and set the difference between the preset speed threshold and the switching speed to be the movement speed of the background page. Based on user experience, it can be determined that when the speed exceeds 120 fps, the user may feel dizzy, and when the speed is less than 60 fps, a lag phenomenon may occur. Therefore, the terminal 1 can set the preset speed threshold, and the preset speed threshold falls within a range from 60 fps to 120 fps. As the movement indication direction of the background page is set to be opposite to the switching indication direction, a sum of the switching speed and the movement speed needs to be equal to the preset speed threshold.

It can be understood that the switching speed and the movement speed are absolute speeds, and the preset speed threshold can be a relative speed relative to movement of the background page when switching from the first page to the second page.

The control unit 13 controls switching from the first page to the second page according to the switching indication information, and controls movement of the background page according to the movement indication direction and the movement speed.

Specifically, the control unit 13 can control switching from the first page to the second page according to the switching indication direction and the switching speed, and control movement of the background page according to the movement indication direction and the movement speed.

What needs to be illustrated is that in the embodiment of the present disclosure, an image displayed in the background page can be any frame image of a combination image combined by at least one frame. That is, an image is independently displayed in the background page every a preset time interval. The control unit 13 can control movement from a first image of the combination image combined by at least one frame displayed in the background page to a second image of the combination image combined by at least one frame according to the movement indication direction and the movement speed, the first image can be a frame of the combination image, and the second image can be a frame of the combination image. Or the image displayed in the background page can be a dynamic image, and the control unit 13 can control movement of a moveable object of the dynamic image displayed in the background page according to the movement indication direction and the movement speed. For example, if the dynamical image includes a little person which is running, and the switching indication direction is sliding toward left of the screen of the terminal 1, the little person can run to the left or run to the right according to the movement indication direction. The specific movement indication direction can be set by the user. Or the image displayed in the background page can be a part of a preset image, and the control unit 13 can control movement from a first part of the preset image displayed in the background page to a second part of the preset image according to the movement indication direction and the movement speed. For example, a part of the preset image is displayed in the background page, and when the background page is moved, the displayed image is coherent.

It can be understood that the switching indication direction can include an upward direction, a downward direction, a left direction, and a right direction of a plane, that is, switching is performed in the plane. Referring to FIG. 3 and FIG. 4, FIG. 3 indicates that before switching from the first page to the second page, a part of a preset image is displayed in the background page. The part can include a pattern 1, and the remaining of the preset image is not displayed. When the switching indication direction indicates that when the terminal controls switching from the first page to the second page in a left direction, the image displayed in the background page can be moved to right, and during the movement process, the image is coherent. As is illustrated by FIG. 4, when the terminal controls switching from the first page to the second page, another part of the preset image can be displayed in the background page. The part includes a pattern 2, and the remaining of the preset image is not displayed. What needs to be illustrated is that the pattern 1 and the pattern 2 are just used to illustrate the process of moving the image of the background page, and the pattern 1 and the pattern 2 can be determined by the preset image which is selected as the background by the user.

The switching indication direction can further include a longitudinal direction of a three-dimension space, for example, when “window” effects switch is performed. Referring to FIG. 5, relative to the terminal 1, a spatial rectangular coordinate system can be set for the background page. If the terminal 1 controls switching from the first page to the second page in the “window” effects manner, that is, when the terminal 1 controls switching from the first page to the second page in a direction parallel to the Z-axis, the image displayed in the background page can be moved in the direction parallel to the Z-axis. For example, if the switching indication direction for switching from the first page to the second page is parallel to the positive direction of the Z-axis, the image displayed in the background page can be moved in the negative direction of the Z-axis. Certainly, the manner of adopting the coordinate axis is just an example for illustrating the longitudinal direction of the three-dimension space, and the terminal may not set the spatial rectangular coordinate system.

In the embodiment of the present disclosure, the switching indication information including the switching indication direction and the switching speed for switching from the first page to the second page is acquired, the movement indication direction and the movement speed of the background page of the first page and the second page are determined according to the switching indication information, the background page is moved according to the movement indication direction and the movement speed, and the movement indication direction is opposite to the switching indication direction, thus a relative movement speed relative to movement of the background page when switching from the first page to the second page increases, and by setting the range of the preset speed threshold, it can be ensured that the effect of relative movement cannot disturb the user, which can further improve user experience.

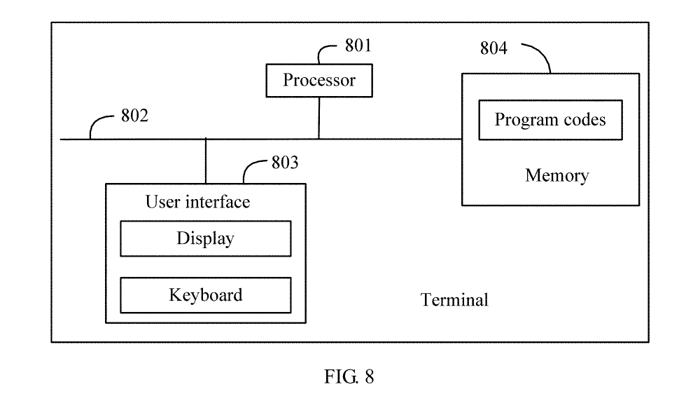

Referring to FIG. 8, a diagrammatic view of a terminal in accordance with another embodiment of the present disclosure is provided. As is illustrated by FIG. 8, the terminal can include at least one processor 801 (for example, a central processing unit), at least one user interface 803, a memory 804, and at least one communication bus 802. The communication bus 802 is configured to realize communication among these components. The user interface 803 can include a display and a keyboard. Optionally, the user interface 803 can further include a standard wired interface and a wireless interface. The memory 804 can be a random-access memory, and can also be a non-volatile memory, for example at least one disc memory. Optionally, the memory 804 can also be a storage device arranged away from the processor 801. The processor 801 can be illustrated in combination with the terminals illustrated by FIG. 6 and FIG. 7. The memory 804 stores a set of program codes. The processor 801 invokes the set of program codes stored in the memory to execute following operations: acquiring switching indication information for switching a first page, the switching indication information including a switching indication direction for switching from the first page to a second page; setting a direction opposite to the switching indication direction to be a movement indication direction of a background page of the first page and the second page; and controlling switching from the first page to the second page according to the switching indication information, and controlling movement of the background page according to the movement indication direction.

In an optional embodiment, the processor 801 invoking the set of program codes stored in the memory 804 to acquire the switching indication information which is for switching a first page and include a switching indication direction for switching from the first page to a second page includes acquiring the switching indication information for switching the first page from a preset input region of the terminal. The switching indication information includes the switching indication direction for switching from the first page to the second page, and the preset input region includes a physical keyboard, a touch screen, or an input region within a preset distance range of the terminal.

In an optional embodiment, the switching indication information further includes a switching speed for switching from the first page to the second page.

In an optional embodiment, after the processor 801 invokes the set of program codes stored in the memory 804 to set the direction opposite to the switching indication direction to be the movement indication direction of the background page of the first page and the second page, the processor 801 further invokes the set of program codes stored in the memory 804 to set a difference between a preset speed threshold and the switching speed to be a movement speed of the background page.

In an optional embodiment, the processor 801 invoking the set of program codes stored in the memory 804 to control switching from the first page to the second page according to the switching indication information and control movement of the background page according to the movement indication direction includes: controlling switching from the first page to the second page according to the switching indication direction and the switching speed, and controlling movement of the background page according to the movement indication direction and the movement speed.

In an optional embodiment, an image displayed in the background page is a dynamic image, a part of a preset image, or any frame image of a combination image combined by at least one frame.

In an optional embodiment, the processor 801 invoking the set of program codes stored in the memory 804 to control movement of the background page according to the movement indication direction and the movement speed includes controlling movement of a moveable object of the dynamic image displayed in the background page according to the movement indication direction and the movement speed.

In an optional embodiment, the processor 801 invoking the set of program codes stored in the memory 804 to control movement of the background page according to the movement indication direction and the movement speed includes controlling movement from a first part of the preset image displayed in the background page to a second part of the preset image according to the movement indication direction and the movement speed.

In an optional embodiment, the processor 801 invoking the set of program codes stored in the memory 804 to control movement of the background page according to the movement indication direction and the movement speed includes controlling movement from a first image of the combination image combined by at least one frame displayed in the background page to a second image of the combination image combined by at least one frame according to the movement indication direction and the movement speed.

In an optional embodiment, the switching indication direction includes an upward direction, a downward direction, a left direction, or a right direction of a plane where the screen of the terminal is in, or the switching indication direction is a longitudinal direction of a three-dimension space and the longitudinal direction is perpendicular to the screen of the terminal.

In the embodiment of the present disclosure, the switching indication information including the switching indication direction for switching from the first page to the second page is acquired, the movement indication direction of the background page of the first page and the second page is determined according to the switching indication information, the background page is moved according to the movement indication direction, and the movement indication direction is opposite to the switching indication direction, thus a relative movement speed relative to movement of the background page when switching from the first page to the second page increases, thereby improving user experience.

In embodiments of the present disclosure, the modules or the units can be realized by a universal integrated circuit (for example, the central processing unit) or an application specific integrated circuit (ASIC).

According to actual need, the order of the steps of the methods in the embodiments of the present disclosure can be adjusted, some steps can be merged into one step, and some step can be deleted.

According to actual need, some modules or units of the device in the embodiments of the present disclosure can be merged into one module or one unit, some module or unit can be divided into several modules or units, and some module or some unit can be deleted.

Persons skilled in the art can understand that all or a part of process can be accomplished by using a computer program to instruct related hardware. All the programs can be stored in a computer-readable storage medium. When the program is executed, the process of the embodiments of the above-mentioned methods can be included. Wherein, the storage medium can be a magnetic disk, an optical disk, a ROM (Read-Only Memory, ROM), a RAM (Random Access Memory, RAM), or the like.

The embodiments described above are merely preferred ones of the present disclosure but are not limitations to the protection scope of the present disclosure, thus equivalent variations made according to the appended claims of the present disclosure still fall within the scope of the present disclosure.

The embodiments described above are merely preferred ones of the present disclosure but are not limitations to the protection scope of the present disclosure, thus equivalent variations made according to the appended claims of the present disclosure still fall within the scope of the present disclosure.

1. A page switching method comprising:
acquiring switching indication information for switching a first page, the switching indication information comprising a switching indication direction for switching from the first page to a second page;
setting a direction opposite to the switching indication direction to be a movement indication direction of a background page of the first page and the second page; and
controlling switching from the first page to the second page according to the switching indication information, and controlling movement of the background page according to the movement indication direction.

2. The method of claim 1, wherein acquiring the switching indication information which is for switching the first page and comprises a switching indication direction for switching from the first page to the second page comprises:
acquiring the switching indication information for switching the first page from a preset input region of a terminal, the switching indication information comprises the switching indication direction for switching from the first page to the second page, and the preset input region comprises a physical keyboard, a touch screen, or an input region within a preset distance range of the terminal.

3. The method of claim 1, wherein the switching indication information further comprises a switching speed for switching from the first page to the second page.

4. The method of claim 3, wherein after setting the direction opposite to the switching indication direction to be the movement indication direction of the background page of the first page and the second page, the method further comprises:
setting a difference between a preset speed threshold and the switching speed to be a movement speed of the background page.

5. The method of claim 4, wherein controlling switching from the first page to the second page according to the switching indication information, and controlling movement of the background page according to the movement indication direction comprises:
controlling switching from the first page to the second page according to the switching indication direction and the switching speed; and
controlling movement of the background page according to the movement indication direction and the movement speed.

6. The method of claim 5, wherein an image displayed in the background page is a dynamic image, a part of a preset image, or any frame image of a combination image combined by at least one frame.

7. The method of claim 6, wherein controlling movement of the background page according to the movement indication direction and the movement speed comprises:
controlling movement of a moveable object of the dynamic image displayed in the background page according to the movement indication direction and the movement speed.

8. The method of claim 6, wherein controlling movement of the background page according to the movement indication direction and the movement speed comprises:
controlling movement from a first part of the preset image displayed in the background page to a second part of the preset image according to the movement indication direction and the movement speed.

9. The method of claim 6, wherein controlling movement of the background page according to the movement indication direction and the movement speed comprises:
controlling movement from a first image of the combination image combined by at least one frame displayed in the background page to a second image of the combination image combined by at least one frame according to the movement indication direction and the movement speed.

10. The method of claim 1, wherein the switching indication direction comprises an upward direction, a downward direction, a left direction, or a right direction of a plane where a screen of a terminal is in, or the switching indication direction is a longitudinal direction of a three-dimension space and the longitudinal direction is perpendicular to the screen of the terminal.

11. A terminal comprising:
a memory storing a set of program codes; and
a processor configured to invoke the set of program codes to execute following operations:
acquiring switching indication information for switching a first page, the switching indication information comprising a switching indication direction for switching from the first page to a second page;
setting a direction opposite to the switching indication direction to be a movement indication direction of a background page of the first page and the second page; and
controlling switching from the first page to the second page according to the switching indication information, and controlling movement of the background page according to the movement indication direction.

12. The terminal of claim 11, wherein acquiring the switching indication information which is for switching the first page and comprises a switching indication direction for switching from the first page to the second page comprises:
acquiring the switching indication information for switching the first page from a preset input region of a terminal, the switching indication information comprises the switching indication direction for switching from the first page to the second page, and the preset input region comprises a physical keyboard, a touch screen, or an input region within a preset distance range of the terminal.

13. The terminal of claim 11, wherein the switching indication information further comprises a switching speed for switching from the first page to the second page.

14. The terminal of claim 13, wherein the set of program codes are further invoked by the processor to set a difference between a preset speed threshold and the switching speed to be a movement speed of the background page.

15. The terminal of claim 14, wherein controlling switching from the first page to the second page according to the switching indication information, and controlling movement of the background page according to the movement indication direction comprises:
controlling switching from the first page to the second page according to the switching indication direction and the switching speed, and controlling movement of the background page according to the movement indication direction and the movement speed.

16. The terminal of claim 15, wherein an image displayed in the background page is a dynamic image, a part of a preset image, or any frame image of a combination image combined by at least one frame.

17. The terminal of claim 16, wherein controlling movement of the background page according to the movement indication direction and the movement speed comprises:
controlling movement of a moveable object of the dynamic image displayed in the background page according to the movement indication direction and the movement speed.

18. The terminal of claim 16, wherein controlling movement of the background page according to the movement indication direction and the movement speed comprises:
controlling movement from a first part of the preset image displayed in the background page to a second part of the preset image according to the movement indication direction and the movement speed.

19. The terminal of claim 16, wherein controlling movement of the background page according to the movement indication direction and the movement speed comprises:
controlling movement from a first image of the combination image combined by at least one frame displayed in the background page to a second image of the combination image combined by at least one frame according to the movement indication direction and the movement speed.

20. The terminal of claim 11, wherein the switching indication direction comprises an upward direction, a downward direction, a left direction, or a right direction of a plane where a screen of a terminal is in, or the switching indication direction is a longitudinal direction of a three-dimension space and the longitudinal direction is perpendicular to the screen of the terminal.
